(19) United States
(12) Patent Application Publication
(10) Pub. No.: US 2015/0002617 A1
(43) Pub. Date: Jan. 1, 2015

(54) ELECTRONIC DEVICE AND VIRTUAL MEETING MANAGING METHOD

(71) Applicant: HON HAI PRECISION INDUSTRY CO., LTD., New Taipei (TW)

(72) Inventors: TING-SHE CHANG, New Taipei (TW); TSUNG-JEN CHUANG, New Taipei (TW)

(21) Appl. No.: 14/315,729

(22) Filed: Jun. 26, 2014

(30) Foreign Application Priority Data
Jun. 28, 2013 (CN) 2013102686618

(51) Int. Cl. H04N 7/15

(52) U.S. Cl. CPC H04N 7/152
USPC 348/14.09

(57) ABSTRACT

An exemplary virtual meeting managing method includes controlling a communication unit to transmit a participant input to a server, controlling the communication unit to receive signals from the server, and controlling a display unit to display a virtual meeting room and actions of a plurality of virtual participants in the virtual meeting room according to the received signals. The method further controls the communication unit to pause the transmission of the participant input to the server and pause the reception of the signals from the server when the participant of the virtual meeting requests to join in a private conference, and establishes a point-to-point/point-to-multipoint connection between/among the participants of the private conference.

### CROSS-REFERENCE TO RELATED APPLICATIONS

This application claims priority to Chinese Patent Application No. 201310268661.8 filed on Jun. 28, 2013 in the China Intellectual Property Office, the contents of which are incorporated by reference herein.

### FIELD

The subject matter herein generally relates to electronic devices, and particularly, to an electronic device capable of establishing a point-to-point/point-to-multipoint connection between/among all the participants of a private conference and a related method.

### BACKGROUND

A virtual meeting is a conference with a number of participants communicating via networks. The virtual meeting allows participants to view the same visual content displayed at substantially the same time while the virtual meeting is ongoing.

### BRIEF DESCRIPTION OF THE DRAWINGS

Implementations of the present technology will now be described, by way of example only, with reference to the attached figures, wherein:

FIG. 1 illustrates a block diagram of an embodiment of an electronic device.

FIG. 2 illustrates a flowchart of an embodiment of a virtual meeting managing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device.

The term “comprising” means “including, but not necessarily limited to”; it specifically indicates open-ended inclusion or membership in a so-described combination, group, series and the like.

Embodiments of the present disclosure will be described with reference to the accompanying drawings.

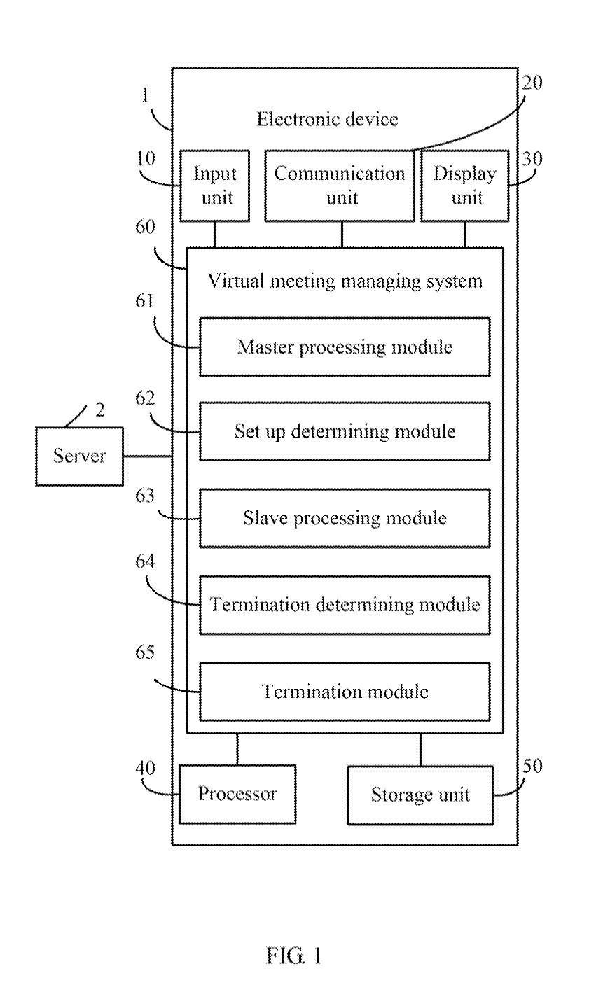

FIG. 1 illustrates a block diagram of an embodiment of an electronic device 1. The electronic device 1 includes an input unit 10, a communication unit 20, and a display unit 30. The input unit 10 can be one or more selected from a group that can include a microphone, a camera, a touch screen, and a keyboard. The input unit 10 can produce a participant input when a user of the electronic device 1 performs an operation in front of the input unit 10, such as performing a gesture in front of the microphone or the camera. The input unit 10 can also produce a participant input when a user of the electronic device 1 operates the input unit 10, for example, operating the touch screen or the keyboard. When the input unit 10 is the microphone, the participant input is sound recorded by the microphone. When the input unit 10 is the camera, the participant input is the video captured by the camera. When the input unit 10 is the touch screen or the keyboard, the participant input is text-based information input through the touch screen or the keyboard.

The electronic device 1 can communicate with other electronic devices 1 and a server 2 via the communication unit 20. Each participant can employ a corresponding electronic device 1 to send the corresponding participant input, such as setting up a virtual meeting or the actions of the participant, to the server 2 via the communication unit 20. The server 2 can accordingly set up a virtual meeting, which is consisted by a virtual meeting room and a number of virtual participants in the virtual meeting room. Each virtual participant is a 3D model of one participant of the virtual meeting. The server 2 can accordingly organize all the virtual participants in the virtual meeting room to perform corresponding actions. The server 2 can further transmit signals of the virtual meeting room and the actions of all the virtual participants in the virtual meeting room to each electronic device 1, thus each electronic device 1 can control the corresponding display unit 30 to display the virtual meeting room and the actions of the virtual participants.

In at least one embodiment, the electronic device 1 can control the communication unit 20 to pause the transmission to the server 2 and pause the reception from the server 2 in response to a request to join in a private conference by the participant of the virtual meeting. The electronic device 1 can further establish a point-to-point/point-to-multipoint connection between/among all the participants of the private conference.

In at least one embodiment, the electronic device 1 includes at least one processor 40 and a storage unit 50. A virtual meeting managing system 60 is applied in the electronic device 1. In at least one embodiment, the virtual meeting managing system 60 includes a master processing module 61, a set up determining module 62, a slave processing module 63, a termination determining module 64, and a termination module 65. One or more programs of the above function modules can be stored in the storage unit 50 and executed by the processor 40. The processor 40 can be a central processing unit, a digital processor, or a single chip, for example. The storage unit 50 can be a hard disk, a compact disk, or a flash memory, for example.

The master processing module 61 is used to control the communication unit 20 to transmit the participant input to the server 2. The master processing module 61 is further used to control the communication unit 20 to receive signals of the virtual meeting room and the actions of all the virtual participants in the virtual meeting room from the server 2. In addition, the master processing module 61 is further used to control the display unit 30 to display the virtual meeting room and the actions of all the virtual participants in the virtual meeting room according to the received signals. In at least one embodiment, the master processing module 61 is further used to control the display unit 30 to display a user interface including the virtual meeting room, the virtual participants, and icons indicating various types of functions such as a set up of the private conference, an invitation of other participants to the private conference, and a termination of the private conference.

The set up determining module 62 is used to determine whether the participant of the virtual meeting requests to join in a private conference. In a first embodiment, the set up determining module 62 determines whether an icon indicating a set up of the private conference is selected. If the icon indicating the set up of the private conference is selected, the set up determining module 62 determines that the participant of the virtual meeting requests to join in the private conference. In a second embodiment, the set up determining module 62 determines whether an invitation request to join in the private conference is received by the set up determining module 62 and whether an agreeing operation to join in the private conference is detected by the set up determining module 62. If the invitation request to join in the private conference is received by the set up determining module 62 and the agreeing operation to join in the private conference is detected by the set up determining module 62, the set up determining module 62 determines that the participant of the virtual meeting requests to join in the private conference.

The slave processing module 63 is used to control the communication unit 20 to pause the transmission of the participant input to the server 2 and pause the reception of the signals from the server 2 when the participant of the virtual meeting requests to join in the private conference. The slave processing module 63 is further used to establish the point-to-point/point-to-multipoint connection between/among the participants of the private conference. Thus, the actions of the participant of the private conference are shared to the participants of the private conference but are not shared with other participants of the virtual meeting. In at least one embodiment, the slave processing module 63 is further used to receive the participant input indicating setting a time of the private conference, and accordingly set the time of the private conference. The time can be a time point indicating an end time of the private conference, or a time range with a starting time of the private conference and an end time of the private conference. In at least one embodiment, the slave processing module 63 is further used to receive a participant input indicating setting a name of the private conference, and accordingly set the name of the private conference. In at least one embodiment, the slave processing module 63 is further used to invite other participants of the virtual meeting to join in the private conference in response to the participant operation to select an icon indicating an invitation of other participants to the private conference.

The termination determining module 64 is used to determine whether the participant of the private conference requests to terminate the private conference. In a first embodiment, the termination determining module 64 determines that the participant of the private conference requests to terminate the private conference when the set time of the private conference is reached. In a second embodiment, the termination determining module 64 determines whether an icon indicating a termination of the private conference is selected. If the icon indicating the termination of the private conference is selected, the termination determining module 64 determines that the participant of the private conference requests to terminate the private conference. In a third embodiment, the termination determining module 64 determines whether a request to terminate the private conference is received by the termination determining module 64. If the request to terminate the private conference is received by the termination determining module 64, the termination determining module 64 determines that the participant of the private conference requests to terminate the private conference. In the third embodiment, when one of the other participants of the private conference selects the icon indicating the terminating of the private conference, another electronic device 1 corresponding to the one participant sends the request to terminate the private conference to the participant.

The termination module 65 is used to terminate the point-to-point/point-to-multipoint connection between/among the participants of the private conference when the participant of the private conference requests to terminate the private conference.

In at least one embodiment, when the point-to-point/point-to-multipoint connection between/among the participants of the private conference is terminated, the master processing module 61 further controls the communication unit 20 to continue transmitting the participant input to the server 2 and controls the communication unit 20 to continue receiving the signals from the server 2. Thus, the actions of the participant can be shared with other participants of the virtual meeting again.

In at least one embodiment, the master processing module 61 and the slave processing module 63 can be combined into one module, and the procedure processed by the master processing module 61 and the slave processing module 63 can be accordingly processed by the combined module.

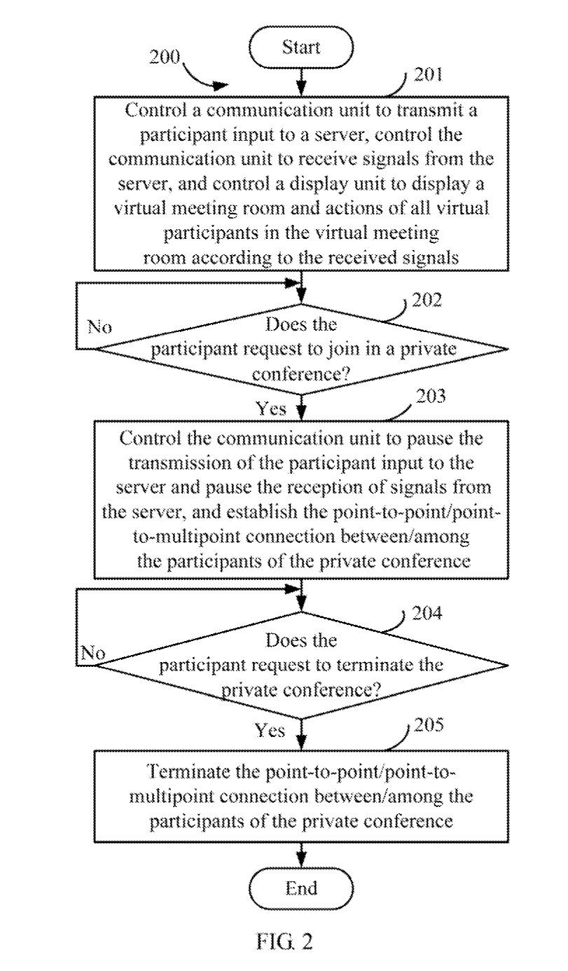

FIG. 2 illustrates a flowchart of an embodiment of a virtual meeting managing method 200. The method 200 is provided by way of example, as there are a variety of ways to carry out the method 200. The method 200 described below can be carried out using the configurations illustrated in FIG. 1, for example, and various elements of these figures are referenced in the explanation of method. Each block shown in FIG. 2 represents one or more processes, methods or subroutines, carried out in the method. Additionally, the illustrated order of blocks is by example only and the order of the blocks can change according to the present disclosure. The method 200 can begin at block 201.

In block 201, a master processing module controls a communication unit to transmit a participant input to a server. The master processing module further controls a communication unit to receive signals of a virtual meeting room and actions of all virtual participants in the virtual meeting room from the server, and controls a display unit to display the virtual meeting room and the actions of all the virtual participants in the virtual meeting room according to the received signals. In at least one embodiment, the master processing module further controls the display unit to display a user interface including the virtual meeting room, the virtual participants, and icons indicating various types of functions such as a set up of the private conference, an invitation of other participants to the private conference, and a termination of the private conference.

In block 202, a set up determining module determines whether the participant of the virtual meeting requests to join in a private conference. If the participant of the virtual meeting requests to join in the private conference, the procedure goes to block 203. If the participant of the virtual meeting does not request to join in the private conference, the procedure goes to block 202. In a first embodiment, the set up determining module determines whether an icon indicating a set up of the private conference is selected. If the icon indicating the set up of the private conference is selected, the set up determining module determines that the participant of the virtual meeting requests to join in a private conference. In a second embodiment, the set up determining module determines whether an invitation request to join in the private conference is received and whether an agreeing operation to join in the private conference is detected. If the invitation request to join in the private conference is received and the agreeing operation to join in the private conference is detected, the set up determining module determines that the participant of the virtual meeting requests to join in a private conference.

In block 203, a slave processing module controls the communication unit to pause the transmission of the participant input to the server and pause the reception of the signals from the server, and establishes a point-to-point/point-to-multipoint connection between/among the participants of the private conference. In at least one embodiment, the slave processing module further receives the participant input indicating setting a time of the private conference, and accordingly sets a time of the private conference. The time can be a time point indicating an end time of the private conference, or a time range with a starting time of the private conference and an end time of the private conference.

In block 204, a termination determining module determines whether the participant of the private conference requests to terminate the private conference. When the participant of the private conference requests to terminate the private conference, the procedure goes to block 205. When the participant of the private conference does not request to terminate the private conference, the procedure goes to block 204. In a first embodiment, the termination determining module determines that the participant of the private conference requests to terminate the private conference when the set time of the private conference is reached. In a second embodiment, the termination determining module determines whether an icon indicating a termination of the private conference is selected. If the icon indicating the termination of the private conference is selected, the termination determining module determines that the participant of the private conference requests to terminate the private conference. In a third embodiment, the termination determining module determines whether a request to terminate the private conference is received. If a request to terminate the private conference is received, the termination determining module determines that the participant of the private conference requests to terminate the private conference. In the third embodiment, when one of the other participants of the private conference selects the icon indicating the termination of the private conference, another electronic device corresponding to the one participant sends the request to terminate the private conference to the participant.

In block 205, a termination module terminates the point-to-point/point-to-multipoint connection between/among the participants of the private conference.

In at least one embodiment, when the point-to-point/point-to-multipoint connection between/among the participants of the private conference is terminated, the master processing module further controls the communication unit to continue transmitting the participant input to the server, and controls the communication unit to continue receiving the signals from the server.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. An electronic device comprising:
a communication unit;
a storage system;
a processor; and
one or more programs stored in the storage system, and executed by the processor, the one or more programs comprising:
a master processing module configured to control the communication unit to transmit a participant input to a server, control the communication unit to receive signals of a virtual meeting room and actions of a plurality of virtual participants in the virtual meeting room from the server, and control a display unit to display the virtual meeting room and the actions of a plurality of virtual participants in the virtual meeting room according to the received signals;
a set up determining module configured to determine whether the participant of the virtual meeting requests to join in a private conference; and
a slave processing module configured to control the communication unit to pause the transmission of the participant input to the server and pause the reception of the signals from the server when the participant of the virtual meeting requests to join in the private conference, and establish a point-to-point/point-to-multipoint connection between/among the participants of the private conference.

2. The electronic device as described in claim 1, wherein the set up determining module is further configured to:
determine whether an icon indicating a set up of the private conference is selected; and
determine that the participant of the virtual meeting requests to join in a private conference when the icon indicating the set up of the private conference is selected.

3. The electronic device as described in claim 1, wherein the set up determining module is configured to:
determine whether an invitation request to join in the private conference is received and whether an agreeing operation to join in the private conference is detected; and
determine that the participant of the virtual meeting requests to join in a private conference when the invitation request to join in the private conference is received and the agreeing operation to join in the private conference is detected.

4. The electronic device as described in claim 1, further comprising a termination determining module and a termination module, wherein:
the termination determining module is configured to determine whether the participant of the private conference requests to terminate the private conference; and
the termination module is configured to terminate the point-to-point/point-to-multipoint connection between/among the participants of the private conference when the participant of the private conference requests to terminate the private conference.

5. The electronic device as described in claim 4, wherein the master processing module is further configured to:
control the communication unit to continue transmitting the participant input to the server when the point-to-point/point-to-multipoint connection between/among the participants of the private conference is terminated, and control the communication unit to continue receiving the signals from the server.

6. The electronic device as described in claim 4, wherein the slave processing module is further configured to receive the participant input indicating setting a time of the private conference, and accordingly set a time of the private conference; and the termination determining module is configured to determine that the participant of the private conference requests to terminate the private conference when the set time of the private conference is reached.

7. The electronic device as described in claim 4, wherein the termination determining module is further configured to:
determine whether a request to terminate the private conference is received; and
determine that the participant of the private conference requests to terminate the private conference when a request to terminate the private conference is received.

8. A virtual meeting managing method comprising:
controlling a communication unit to transmit a participant input to a server, controlling the communication unit to receive signals of a virtual meeting room and actions of a plurality of virtual participants in the virtual meeting room from the server, and controlling a display unit to display the virtual meeting room and the actions of a plurality of virtual participants in the virtual meeting room according to the received signals;
determining whether the participant of the virtual meeting requests to join in a private conference; and
controlling the communication unit to pause the transmission of the participant input to the server and pause the reception of the signals from the server when the participant of the virtual meeting requests to join in the private conference, and establishing a point-to-point/point-to-multipoint connection between/among the participants of the private conference.

9. The virtual meeting managing method as described in claim 8, wherein the method further comprises:
determining whether an icon indicating a set up of the private conference is selected; and
determining that the participant of the virtual meeting requests to join in a private conference when the icon indicating the set up of the private conference is selected.

10. The virtual meeting managing method as described in claim 8, wherein the method further comprises:
determining whether an invitation request to join in the private conference is received and whether an agreeing operation to join in the private conference is detected; and
determining that the participant of the virtual meeting requests to join in a private conference when the invitation request to join in the private conference is received and the agreeing operation to join in the private conference is detected.

11. The virtual meeting managing method as described in claim 8, wherein the method further comprises:
determining whether the participant of the private conference requests to terminate the private conference; and
terminating the point-to-point/point-to-multipoint connection between/among the participants of the private conference when the participant of the private conference requests to terminate the private conference.

12. The virtual meeting managing method as described in claim 11, wherein the method further comprises:
controlling the communication unit to continue transmitting the participant input to the server when the point-to-point/point-to-multipoint connection between/among the participants of the private conference is terminated, and controlling the communication unit to continue receiving the signals from the server.

13. The virtual meeting managing method as described in claim 11, wherein the method further comprises:
receiving the participant input indicating setting a time of the private conference, and accordingly setting a time of the private conference; and
determining that the participant of the private conference requests to terminate the private conference when the set time of the private conference is reached.

14. The virtual meeting managing method as described in claim 11, wherein the method further comprises:
determining whether a request to terminate the private conference is received; and
determining that the participant of the private conference requests to terminate the private conference when a request to terminate the private conference is received.

15. A non-transitory storage medium storing a set of instructions, the set of instructions capable of being executed by a processor of an electronic device, causing the electronic device to perform a virtual meeting managing method, the method comprising:
controlling a communication unit to transmit a participant input to a server, controlling the communication unit to receive signals of a virtual meeting room and actions of a plurality of virtual participants in the virtual meeting room from the server, and controlling a display unit to display the virtual meeting room and the actions of a plurality of virtual participants in the virtual meeting room according to the received signals;
determining whether the participant of the virtual meeting requests to join in a private conference; and
controlling the communication unit to pause the transmission of the participant input to the server and pause the reception of the signals from the server when the participant of the virtual meeting requests to join in the private conference, and establishing a point-to-point/point-to-multipoint connection between/among the participants of the private conference.

16. The non-transitory storage medium as described in claim 15, wherein the method further comprises:
determining whether an icon indicating a set up of the private conference is selected; and
determining that the participant of the virtual meeting requests to join in a private conference when the icon indicating the set up of the private conference is selected.

17. The non-transitory storage medium as described in claim 15, wherein the method further comprises:
determining whether an invitation request to join in the private conference is received and whether an agreeing operation to join in the private conference is detected; and
determining that the participant of the virtual meeting requests to join in a private conference when the invitation request to join in the private conference is received and the agreeing operation to join in the private conference is detected.

18. The non-transitory storage medium as described in claim 15, wherein the method further comprises:
determining whether the participant of the private conference requests to terminate the private conference; and
terminating the point-to-point/point-to-multipoint connection between/among the participants of the private conference when the participant of the private conference requests to terminate the private conference.

19. The non-transitory storage medium as described in claim 18, wherein the method further comprises:
receiving the participant input indicating setting a time of the private conference, and accordingly setting a time of the private conference; and
determining that the participant of the private conference requests to terminate the private conference when the set time of the private conference is reached.

20. The non-transitory storage medium as described in claim 18, wherein the method further comprises:
determining whether a request to terminate the private conference is received; and
determining that the participant of the private conference requests to terminate the private conference when a request to terminate the private conference is received.
